(19) United States
(12) Patent Application Publication
(10) Pub. No.: US 2025/0379835 A1
(43) Pub. Date: Dec. 11, 2025

(54) METHOD, SERVER, AND USER TERMINAL FOR PROVIDING CHATBOT SERVICE

(71) Applicant: KAKAO CORP., Jeju-si (KR)

(72) Inventors: Dong Hyun BAN, Seongnam-si, Gyeonggi-do (KR); Soo Bum KIM, Seongnam-si (KR); Jae Young JANG, Seongnam-si (KR); Bo Mi HONG, Seongnam-si (KR); Jeong Um LEE, Seoul (KR); Ho Geun KWAK, Seongnam-si (KR); Jeong Hyeon LEE, Seongnam-si (KR); Jun Yong AHN, Seongnam-si (KR); Ji Soo HWANG, Seongnam-si (KR); Mu Tae YANG, Seongnam-si (KR); Hyeok Jin KWON, Seongnam-si (KR); Min Jeong KANG, Seongnam-si (KR); Gi Pyo KIM, Seongnam-si (KR); Ka Young SONG, Seongnam-si (KR); Seung Uk JEONG, Seongnam-si (KR); Sung Yong CHANG, Seongnam-si (KR); Jeong Ryeol CHOI, Seongnam-si (KR); Jeong Ho JO, Seongnam-si (KR); Yu Jin HUH, Seongnam-si (KR); Ye Ram HAN, Seongnam-si (KR); Gi Woo KANG, Seongnam-si (KR); Su Woong BYUN, Seongnam-si (KR); Young Eun KIM, Seongnam-si (KR); Tae In KIM, Seoul (KR); Hyeong Woo KIM, Seongnam-si (KR); Bo Kyung KIM, Seongnam-si (KR); Kyeong Un CHOI, Seongnam-si (KR); Hyeon Mo JEONG, Seongnam-si (KR); Chang Hwa JOA, Seongnam-si (KR); O Seok HAN, Seoul (KR); No Suk MYUNG, Seongnam-si (KR); Yun Ho CHOI, Seongnam-si (KR); Minna YOUN, Seongnam-si (KR)

(21) Appl. No.: 19/214,911

(22) Filed: May 21, 2025

(30) Foreign Application Priority Data
Jun. 10, 2024 (KR) 10-2024-0075315

(51) Int. Cl. H04L 51/02; H04L 51/216

(52) U.S. Cl. CPC H04L 51/02; H04L 51/216

(57) ABSTRACT

Proposed is a method for providing a chatbot service by a server. The method may include providing a first chatbot service to enable one-on-one chatting with a first chatbot. The method may also include, in response to a request received from a user terminal to add a second chatbot to a chat room where a plurality of user accounts participate, providing a second chatbot service through the chat room to enable chatting with the second chatbot. The first chatbot and second chatbot may operate in a corresponding relationship.

### CROSS-REFERENCE TO RELATED APPLICATION

This application claims priority to and the benefit of Korean Patent Application No. 10-2024-0075315 filed on Jun. 10, 2024, the disclosure of which is incorporated herein by reference in its entirety.

### BACKGROUND

### Technical Field

The present disclosure relates to a method for providing a chatbot service through a chat room by a server.

### Description of Related Technology

Recent chatbots can interact with users through conversational interfaces. These chatbots may be primarily used in chat services or on specific platforms. Users may communicate with a chatbot by entering text-based messages. To answer users' questions or provide services, the chatbots generates response messages using predetermined information and algorithms.

### SUMMARY

One aspect is to provide a chatbot service in a chat room through a chatbot added to the chat room in which a plurality of user accounts participate, thereby simultaneously providing the chatbot service to the plurality of user accounts participating in the chat room.

Another aspect is to improve the convenience of chatbot services by providing different chatbots operating in a corresponding relationship as different types of chatbot services, while providing correspondence information according to the corresponding relationship to a user terminal.

Another aspect is a method for providing a chatbot service by a server, that includes: providing a first chatbot service to enable one-on-one chatting with a first chatbot; and in response to a request received from a user terminal to add a second chatbot to a chat room where a plurality of user accounts participate, providing a second chatbot service through the chat room to enable chatting with the second chatbot. The first and second chatbots operate in a corresponding relationship.

First chatbot information provided through the first chatbot service and second chatbot information provided through the second chatbot service may include correspondence information associated with the corresponding relationship.

The correspondence information may include at least one of chatbot name information, chatbot profile information, chatbot profile image information, chatbot guide information, and predefined command information requesting a chatbot to provide a message.<

The command information may include at least one command interface that is provided for selection by a user account.

The providing of the second chatbot service may include providing a connection interface for connecting to the first chatbot service through the chat room.

The providing of the connection interface may include: receiving, from a terminal of an account participating in the chat room, interaction information for at least one of profile information and a message of the second chatbot provided through the chat room; and in response to the interaction information, providing information comprising the connection interface to the terminal of the account participating in the chat room.

The method may further include providing the message through the different chat room in response to a request to share a message of the second chatbot, which is provided through the chat room, with a different chat room. The providing of the message through the different chat room may include providing a connection interface for connecting to the first chatbot service through at least one of profile information and the message of the second chatbot provided through the different chat room.

The method may further include providing the message through the different chat room in response to a request to share a message of the second chatbot, which is provided through the chat room, with a different chat room. The providing of the message through the different chat room may include providing a chatbot add interface for adding the second chatbot to the different chat room.

The providing of the second chatbot service may include: providing a chatbot add interface for adding a chatbot to the user terminal through the chat room and receiving an interaction with the interface from the user terminal; and providing a chatbot list comprising the second chatbot to the user terminal.

The method may further include: after the providing of the second chatbot service, providing the first chatbot service to a terminal of an account participating in the chat room. The providing of the first chatbot service to the terminal of the account participating in the chat room may include providing the terminal with a message of the first chatbot based on a usage history associated with the second chatbot service.

In the providing of the first and second chatbot services, the messages of the first and second chatbots may be acquired from a same chatbot engine. The chatbot engine may be included in the server or accessible by the server.

The providing of the second chatbot service may further include suspending provision of the second chatbot service when the message of the second chatbot satisfies a predefined condition.

Another aspect is a server providing chatbot services, that includes a memory storing instructions, and a processor configured to execute the instructions to: provide a first chatbot service to enable one-on-one chatting with a first chatbot; and in response to a request received from a user terminal to add a second chatbot to a chat room where a plurality of user accounts participate, providing a second chatbot service to enable chatting with the second chatbot through the chat room. The first and second chatbots operate in a corresponding relationship.

Another aspect is a method for providing a chatbot service to a user terminal, that includes: providing information on a first chatbot service to enable one-on-one chatting with a first chatbot for a user account; displaying information on a second chatbot added to a chat room where a plurality of user accounts participate; and providing information on a second chatbot service associated with the second chatbot through the chat room. The first and second chatbots operate in a corresponding relationship.

The providing of the information on the second chatbot service may include displaying, through the chat room, a connection interface for connecting to a one-on-one chat service with the first chatbot.

The displaying of the connection interface may include: receiving an interaction from a user with at least one of profile information and a message of the second chatbot, which is included in the information on the second chatbot; and displaying the connection interface in response to the interaction.

The method may further include displaying, through the third chat room, information indicating that the information on the second chatbot is shared with the third chat room. The displaying of the information indicating that the information on the second chatbot is shared with the third chat room may include displaying a connection interface for connecting to a one-on-one chat service with the first chatbot, through the information on the second chatbot displayed through the third chat room.

The displaying of the information on the second chatbot may include: displaying a chatbot add interface for adding a chatbot to the second chat room and receiving an interaction from a user with the interface; and in response to the interaction, displaying a chatbot list comprising the second chatbot.

Another aspect is a user terminal providing a chatbot service, that includes a memory storing instructions, and a processor configured to execute the instructions to: provide information on a first chatbot service to enable one-on-one chatting with a first chatbot for a user account; display information on a second chatbot added to a chat room where a plurality of user accounts participate; and provide information on a second chatbot service associated with the second chatbot through the chat room. The first and second chatbots operate in a corresponding relationship.

### BRIEF DESCRIPTION OF THE DRAWINGS

FIG. 1 is a diagram illustrating an example of a network environment according to one embodiment of the present disclosure.

FIG. 2 is a flowchart illustrating a method for providing a chatbot service by a server of the present disclosure.

FIGS. 3 to 12 illustrate screens in a method for displaying a chatbot service by a user terminal according to one embodiment of the present disclosure.

FIG. 13 is a flowchart illustrating a method for displaying a chatbot service by a user terminal of the present disclosure.

### DETAILED DESCRIPTION

Users may acquire information quickly and conveniently through chatbots. Specifically, chatbots can automate routine tasks. In addition, users may receive personalized services and engage in real-time interactions to acquire information conveniently. Thanks to advances in artificial intelligence and natural language processing technologies, chatbots are now capable of providing more natural and human-like conversations.

However, due to rapid technological advancements and the growing complexity of information, chatbots are finding it increasingly difficult to provide accurate and comprehensive information. As a result, there is a growing demand for improvement in the accuracy and reliability of information provided by chatbots.

Hereinafter, exemplary embodiments disclosed in this specification will be described in detail with reference to the accompanying drawings. Identical or similar components will be designated by the same reference numerals regardless of the drawing symbols, and redundant descriptions will be omitted. In addition, in the description of the embodiments disclosed in this specification, detailed descriptions of related known technologies will be omitted when it is determined that such descriptions may obscure the gist of the disclosed embodiments.

While terms including ordinal numbers, such as “first” and “second,” etc., may be used to describe various components, such components are not limited by the above terms. These terms are generally only used to distinguish one component from another.

Unless stated otherwise, an expression of singularity is intended to include expressions of plurality.

In this application, the described steps may be carried out in any sequence, except in cases where a clearly defined cause-and-effect relationship necessitates a specific order.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, the present disclosure will be described with reference to the attached drawings.

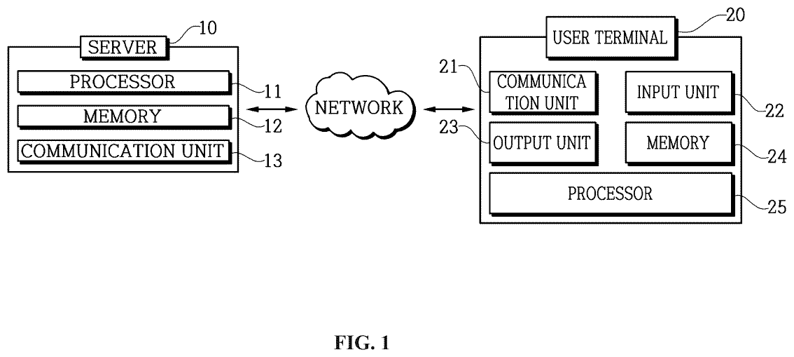

A network environment according to one embodiment of the present disclosure illustrated in FIG. 1 may include a server 10 and a user terminal 20. The user terminal 20 may include at least one terminal connected to the server 10 via a network. In FIG. 1, the user terminal 20 is illustrated as an example of a user terminal.

The user terminal 20 refers to a terminal used by a user logging in with a user account registered on the server 10.

Hereinafter, for convenience of explanation, the user terminal 20 will be described as a terminal that adds a chatbot to a chat room. However, the present invention is not limited to or defined by the functions that may be performed depending on the terminal.

The server 10 may be connected to a user terminal via a network. In addition, the server 10 may be connected to other terminals participating in a chat room via the network. The user terminal 20 may be one of the terminals participating in the chat room. Among the terminals participating in the chat room, there may be a terminal that is distinct from the user terminal 20 and is participating in the chat room without adding a chatbot to the chat room.

Communication schemes for a network are not limited. The communication schemes may include not only a communication scheme to utilize a telecommunication network (for example, a mobile communication network, wired Internet, wireless Internet, and a broadcast network), but also a short-range radio communication scheme.

In the present disclosure, the server 10 may be a device capable of transmitting and receiving information through communication with a terminal via the network. The server 10 may be implemented as a computer device or a plurality of computer devices that provide commands, codes, files, contents, services, etc.

The server 10 may include a processor 11, a memory 12, and a communication unit 13.

The processor 11 controls the overall operation of the memory 12 and the communication unit 13 to provide a chatbot response message to the terminal. Specifically, the processor 11 may be configured to receive a command from a user and provide a response message corresponding to the command.

The memory 12 functions as a storage medium and may store a number of application programs running on the server 10, and data and commands for the operation of the server 10. In one embodiment, an application providing a chat service associated with a chatbot service may be stored in the memory 12.

The memory 12 may be provided in the form of any of various hardware storage devices such as a read only memory (ROM), a random access memory (RAM), a flash drive, hard drive, etc., or may be provided in the form of a web storage.

The communication unit 13 may communicate with a terminal via a network in a wired or wireless manner.

The server 10 may include a messaging server, a channel server, and a chatbot server.

The messaging server may receive an input message to a chatbot from a user terminal 20. Specifically, the user terminal 20 may transmit an input message to the chatbot to the messaging server through a one-on-one chat room (first chatbot service) or a chat room where a plurality of user accounts participate (second chatbot service). When the messaging server receives the input message, the messaging server identifies whether a chatbot service is available in the chat room that received the input message. If the chatbot service is available, the messaging server may transmit the received message to the channel server to specify a channel.

The channel server may verify identification ID (unique identification number) of the message received from the messaging server. In this case, a channel refers to a service that allows a specific company, brand, platform, public institution, or media to communicate with users through a chat room. A channel operator may create an official profile account within the chat service by setting the channel's profile information, channel information, and the like.

In general, a specific chatbot service may be provided for a specific channel. Depending on the chatbot service provided, the response message generated from the chatbot server may vary. Therefore, the channel server may specify a chatbot service by comparing identification ID of a received message with channel ID. Then, the channel server may transmit a user's input message to the chatbot server to generate a response message.

The chatbot server may analyze the user's input message and generate an appropriate response message. Specifically, the messaging server may use a large language model (LLM) or other artificial intelligence models to identify the user's intent. Then, an answer matching the user's intent may be generated and provided to the user. In some cases, the chatbot server may provide a response message to the messaging server, and the messaging server may provide a response message to the user terminal 20 through the chat room.

The server 10 of the present disclosure may provide a chatbot service to the user terminal 20. Specifically, the server 10 may provide the user terminal 20 with a chatbot service through a chat room where a plurality of user accounts participate.

In the present disclosure, the server 10 provides a first chatbot service to enable one-on-one chatting with a first chatbot, and when a request to add a second chatbot to a chat room where a plurality of user accounts participate is received from the user terminal 20, the server 10 may provide a second chatbot service through the chat room to enable chatting with the second chatbot. In this case, the first and second chatbots operate in a corresponding relationship, and first chatbot information provided through the first chatbot service and second chatbot information provided through the second chatbot service may include correspondence information associated with the corresponding relationship.

In this case, a chatbot service refers to a service that provides information generated by a chatbot to users of the chatbot service in the form of chat messages. Each chatbot may provide information requested by a user or information associated with the user in the form of chat messages. Each user and each chatbot may exchange information through mutual interaction, such as chatting. Specifically, a user may request information from a chatbot through a command, and the chatbot may provide information generated in response to the command in the form of a message.

In the present disclosure, the server 10 is equipped with a plurality of chatbots and may provide a plurality of chatbot services with various functions and types based on the plurality of chatbots. The plurality of chatbots may have different topics, themes, functions, target users, etc. For example, the plurality of chatbots may include NewsBot that provides the latest news information, BookingBot that provides a golf reservation function, and WeatherBot that provides weather information.

In the present disclosure, a chatbot service may be divided into a plurality of types. Specifically, a first-type chatbot service refers to a service that provides a chatbot message to a user based on one-on-one chatting between a chatbot and the user. In the first-type chatbot service, a chat room where the chatbot message is provided may be a chat room where only the chatbot and a single user participate.

In addition, a second-type chatbot service refers to a service that provides chatbot messages to a plurality of user accounts through a chat room where the plurality of user accounts participate. In the second-type chatbot service, the chat room where the chatbot message is provided may be a chat room where at least two or more accounts, including a user account, participate. In the second-type chatbot service, a chatbot may be added to the chat room and provide messages.

In relation to the aforementioned types of chatbot services, a chatbot may also be divided into a plurality of types. The first-type chatbot is associated with a first-type chatbot service and provides chatbot messages of the first-type chatbot service. A second-type chatbot is associated with a second-type chatbot service and provides chatbot messages of the second-type chatbot service.

In the present disclosure, the first chatbot service is an example of the first-type chatbot service, and the second chatbot service is an example of the second-type chatbot service. In addition, the first chatbot is an example of the first-type chatbot, and the second chatbot is an example of the second-type chatbot.

In some cases, one of the first-type chatbot services and one of the second-type chatbot services may operate in a corresponding relationship. In the present disclosure, the first and second chatbot services are described as operating in a corresponding relationship. Since the first chatbot service and the second chatbot service operate in a corresponding relationship, the first and second chatbots may also operate in a corresponding relationship.

In this case, the corresponding relationship between the chatbots means that the chatbots have the same or similar topics, themes, functions, target users, profile information, chatbot interfaces, guide information, command information, and the like. In the present disclosure, the first and second chatbots correspond to the first- and second-type chatbots, respectively, but may operate in a corresponding relationship.

For example, while the first chatbot provides a chatbot service for one-on-one chat (first-type chatbot service) and the second chatbot is added to a chat room to provide a chatbot service (second-type chatbot service), both the first and second chatbots may be chatbots that provide the latest news information. In this case, the first and second chatbots may operate in a corresponding relationship. The characteristics of the corresponding relationship between the first and second chatbots will be explained in more detail below.

In this case, the chatbot information refers to information that the server 10 provides to the user terminal 20 or a terminal participating in a chat room, in relation to the chatbot service. The chatbot information may include chatbot message information. The chatbot message information may be a chatbot message generated by a chatbot and provided in the form of a spoken message from the chatbot. A spoken message from the chatbot may be provided with profile information of a speaker (chatbot) for the message.

The chatbot information may include additional information associated with the chatbot. In this case, information associated with the chatbot is not in the form of a spoken message from the chatbot, but refers to information associated with the chatbot provided in relation to the chatbot service. Information associated with a chatbot may include, for example, chatbot name information, chatbot profile information, chatbot profile image information, chatbot guide information, chatbot type information, command information, and the like. The information associated with a chatbot may be provided in the form of system messages, feed messages, and guide messages from the server 10 rather than in the form of spoken messages from the chatbot.

The user terminal 20 may include a user terminal 20 that adds the first chatbot to a chat room.

The user terminal 20 may include a communication unit 21, an input unit 22, an output unit 23, a memory 24, and a processor 25.

The communication unit 21 may communicate with the server 10 or other terminals in a wired or wireless manner.

The input unit 22 may receive various information through the user's manipulation and input actions. Such input unit 22 may be a touch screen module, a keyboard, a mouse, a button, a camera, a stylus, a microphone, etc.

The user terminal 20 may receive a user's interaction through the input unit 22. The interaction refers to a process where a user manipulate the input unit 22 to input information reflecting his or her choices or intentions into the user terminal. For example, the interaction may include touching on a touchscreen, clicking with a mouse, typing on a keyboard, providing voice input through a microphone, capturing an image using a camera, recognizing movements through a motion sensor, and the like.

The output unit 23 may output various information. The output unit 23 may be a display device, a speaker, a vibration generating device, a tactile generating device, etc. In some cases, the output unit 23 may be a device (e.g., Bluetooth earphones) that is connected to a user terminal through wired or wireless communication (e.g., short-range radio communication such as Bluetooth) to receive and output a signal.

The memory 24 functions as a storage medium and may store a number of application programs running on the user terminal 20, and data and commands for the operation of the user terminal 20. This memory 24 may be provided in the form of any of various hardware storage devices such as a read only memory (ROM), a random access memory (RAM), a flash drive, hard drive, etc., or may be provided in the form of a web storage.

In one embodiment, an application providing a chat service associated with a chatbot service of the present disclosure may be stored in the memory 24.

The processor 25 may execute an application that provides a chat service by controlling the overall operation of the communication unit 21, the input unit 22, the output unit 23, and the memory 24.

In the present disclosure, the user terminal 20 may display information on the first chatbot service to enable one-on-one chatting with a first chatbot for a user account, display information on a second chatbot in a chat room where a plurality of user accounts participates, and provide information on a second chatbot service associated with the second chatbot through the chat room. In this case, the first and second chatbot services operate in a corresponding relationship, and the first and second chatbot information may include correspondence information associated with the corresponding relationship.

The first chat room displayed by the user terminal 20 refers to a chat room associated with the first chatbot service, and the second chat room refers to a chat room associated with the second chatbot service.

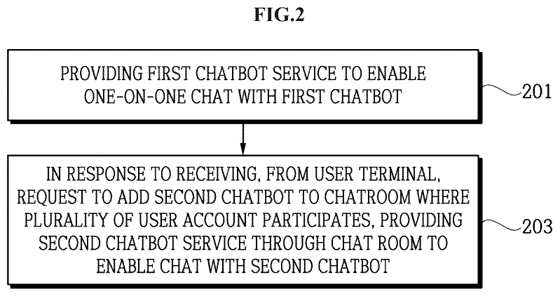

Hereinafter, one embodiment of a method for providing a chatbot service by the server 10 of the present disclosure will be described with reference to FIGS. 2 to 12.

FIG. 2 is a flowchart illustrating a method for providing a chatbot service by a server 10 of the present disclosure.

In operation 201, the server 10 provides a first chatbot service to enable one-on-one chatting with a first chatbot.

The server 10 may provide a chatbot service through a chat service. Specifically, the server 10 may provide the first chatbot service not only to a user terminal 20 and a terminal participating in the chat room, but also to a user terminal of another chat service. In this case, the first chatbot service refers to a service that enables chatting with a chatbot or a specific function through a one-on-one chat room with the chatbot. The second chatbot service refers to a service that enables chatting with a chatbot or a specific function through a chat room where a plurality of user accounts participate. In this case, the first and second chatbots may operate in a corresponding relationship.

For convenience of explanation, the following description will be given using an example where the server 10 provides a first chatbot service to the user terminal 20. However, it is also possible for the user terminal 20 to use only a second chatbot service in operation 203, without using the first chatbot service in operation 201.

The server 10 may provide a plurality of first-type chatbot services including the first chatbot service. The server 10 may provide information on the first chatbot service to the user terminal 20 through a list of available first-type chatbot services or a chatbot service search function.

When a request to use the first chatbot service is received from the user terminal 20, the server 10 may provide the first chatbot service to the user terminal 20 through a first chat room. In this case, the first chat room may be a one-on-one chat room between the first chatbot and a user account of the user terminal 20. Therefore, the addition or participation of any account other than the user account of the user terminal 20 in the first chat room may be restricted.

When the user terminal 20 requests to use the first chatbot service, the server 10 may create a new first chat room to provide the first chatbot service. Specifically, the server 10 may provide a new first chat room by adding the new first chat room to a list of participating chat rooms of the user account.

In some cases, if the user terminal 20 has previously used the first chatbot service, there may be a previously created first chat room. In this case, the first chatbot service may be provided through the existing first chat room, rather than creating a new first chat room. However, when the user terminal 20 uses the first chatbot service for the first time or when the previously created first chat room is deleted, the server 10 may create and provide a new first chat room.

In addition, when the user terminal 20 uses the first chatbot service, the server 10 may provide the first chatbot by adding the first chatbot to a friend list of the user account in the chat service. In this case, the chatbot may be distinguished from other user accounts on the friends list of the user account.

The server 10 may provide the first chatbot service through the first chat room. Specifically, the server 10 may provide first chatbot information through the first chat room. The first chatbot information provided in the first chatbot service may include messages of the first chatbot and information associated with the first chatbot.

For example, the server 10 may provide, through the first chat room, information generated by the first chatbot in the form of a first chatbot message. The first chatbot message may be provided in the form of a response message to a command message from the user account of the user terminal 20. In addition, the first chatbot message may be provided in the form of a spoken message from the first chatbot. A spoken message from the first chatbot may be displayed to correspond to profile information of the message speaker. In addition, the server 10 may provide profile information (including name, profile image, etc.) and guide messages (including functions, usage methods, command information, etc.) for the first chatbot.

In operation 201, while providing the first chatbot service, the server 10 may provide features and functions associated with the corresponding relationship between the first and second chatbots. This will be explained in detail below.

In operation 203, when a request to add a second chatbot to a chat room where a plurality of user accounts participate (hereinafter, referred to as a second chat room) is received from the user terminal 20, the server 10 provides a second chatbot service through a second chat room to enable chatting with the second chatbot. In this case, the second chatbot may operate in a corresponding relationship with the first chatbot.

The second chatbot service may be provided through the second chat room where a plurality of user accounts participate. To this end, the second chatbot may be added to the chat room. The second chat room may be a chat room created before the second chatbot is added. The second chat room may be a chat room with at least two user accounts participating before the second chatbot is added. The user accounts participating in the second chat room may have chatted in the chat room before the addition of the second chatbot.

The server 10 may receive a request to add the second chatbot to the second chat room from the user terminal 20. First, the server 10 may provide the user terminal 20 with an interface for starting a second-type chatbot service. Specifically, the server 10 may provide an interface displayed as ‘Chatroom Chatbot Service’ or ‘Add Chatbot’ to the user terminal 20 through the second chat room.

The server 10 may provide a chatbot list including at least one chatbot that can be added to the second chat room to provide a chatbot service to the user terminal 20. The chatbot list may include the second chatbot. Chatbots included in the chatbot list may correspond to second-type chatbots. The user terminal 20 may be provided with the chatbot list and may select a chatbot to add based on functions, features, and the like of the chatbots in the chatbot list.

The server 10 may provide the chatbot list with various information associated with the chatbots. For example, if there is a first-type chatbot operating in a corresponding relationship with a second-type chatbot included in the chatbot list (that is, if the server 10 provides the first-type chatbot service), the various information associated with the chatbots may be included in and provided through the chatbot list. In addition, if the user terminal 20 is using a first-type chatbot operating in a corresponding relationship with a second type chatbot included in the chatbot list, the various information associated with the chatbots may be included in and provided through the chatbot list.

When the user terminal 20 selects the second chatbot as a chatbot to be added to the second chat room, the server 10 may allow the second chatbot to participate in the second chat room. The server 10 may provide the user terminal 20 with information associated with participation of the second chatbot in the second chat room. Specifically, the server 10 may provide the user terminal 20 with new participation (addition) information of the second chatbot and a greeting message or user guide message from the second chatbot.

When the second chatbot participates in the second chat room, the server 10 may provide a second chatbot service through the second chat room. Specifically, the server 10 may provide second chatbot information through the second chat room. The second chatbot information may be provided to a plurality of user terminals 20 through the second chat room.

The second chatbot information provided as a second chatbot service may include messages of the second chatbot and information associated with the second chatbot. For example, the server 10 may provide, through the second chat room, information generated by the second chatbot in the form of a second chatbot message. The second chatbot message may be provided in the form of a response message to a command message from the user account of the user terminal 20 or a user account participating in the second chat room. The message from the second chatbot may be provided in the form of a spoken message from the second chatbot. In addition, the server 10 may provide profile information (including name, profile image, etc.) and guide messages (including functions, usage methods, command information, etc.) for the second chatbot.

In operations 201 and 203, while providing the first and second chatbot services, the server 10 may provide characteristics and functions associated with the corresponding relationship between the first and second chatbots.

The first chatbot information and the second chatbot information provided through the chatbot service may include correspondence information associated with the corresponding relationship. The correspondence information may include at least one of chatbot name information, chatbot profile information, chatbot profile image information, chatbot guide information, and predefined command information requesting a chatbot to provide a message.

For example, the name information or profile image information of the first chatbot provided through the first chatbot service may be identical to the name information or profile image information of the second chatbot provided through the second chatbot service. In this case, the chatbot name information or the chatbot profile image information may be the correspondence information associated with the corresponding relationship. In some cases, the first and second chatbots may use exactly the same single profile. In such cases, all information on the first and second chatbots may be correspondence information.

Based on the correspondence information, the user accounts participating in the chat room may identify that the first and second chatbots operate in a corresponding relationship. When a user account participating in a chat room identify this corresponding relationship, the user account may easily access and use a different chatbot having the corresponding relationship with the chatbot currently in use.

In some cases, the first and second chatbots may include different name or profile image information. Specifically, depending on the settings configured by the operator of the first and second chatbot systems, the first and second chatbots may include different information. In this case, the correspondence information between the first and second chatbots may not be included.

In addition, when providing a second chatbot service to a second chat room, the server 10 may provide, through the second chat room, a connection interface for connecting to the first chatbot service. That is, the second chat room is a chat room that provides a second chatbot service, but the server 10 may provide, through the second chat room, the connection interface for connecting to the first chatbot.

Specifically, while providing the second chatbot service, the server 10 may provide profile information or message of the second chatbot through the second chat room. When the server 10 receives an interaction from the user terminal 20 with the profile information or message, the server 10 may provide the user terminal 20 with second chatbot home information in which information on the second chatbot is displayed. For example, a chatbot home may be a chatbot's profile page corresponding to a user's profile page, or may be a separate guide page for the chatbot. Through the second chatbot home information, the server 10 may provide information on the corresponding relationship between the first and second chatbots and a connection interface for connecting to the first chatbot service.

In some cases, a message from the second chatbot may include an interface for connecting to a second chatbot home or an interface for connecting directly to the first chatbot service.

By doing so, the server 10 may provide the plurality of user terminals participating in the second chat room with improved connectivity between the first chatbot service and the second chatbot service. A user account participating in the second chat room may wish to use an additional second chatbot service while using the second chatbot service through the second chat room. However, the user account participating in the second chat room may wish to use a chatbot service through a one-on-one chat room with a chatbot, rather than the second chat room with other user accounts participating. If the server 10 provides, through the second chatbot service, a connection interface for connecting to the first chatbot service, there is an advantage in that a user account participating in the second chat room is able to easily access the first chatbot service through the connection interface provided through the second chat room.

In addition, when the server 10 provides the second chatbot service to the second chat room, the server 10 may receive a request from the user terminal 20 to share a message from the second chatbot with a third chat room. In this case, the third chat room is a chat room distinct from the first and second chat rooms. That is, the third chat room may be a chat room distinct from the first and second chat rooms and configured to allow participation of a plurality of user accounts. In response to the request for sharing, the server 10 may provide, through the third chat room, the message from the second chatbot, which is requested to be shared.

The user account participating in the third chat room may receive the second chatbot's message through the third chat room and may wish to use the second chatbot service. However, unlike the second chat room, the third chat room may not have the second chatbot added. In this case, the user account participating in the third chat room may not be able to use the second chatbot service in the third chat room.

When providing the third chat room with the second chatbot message that is requested to be shared, the server 10 may provide, through the second chatbot's message, a connection interface for connecting to the first chatbot service. Specifically, the connection interface for connecting to the first chatbot service may be included in the second chatbot's message provided through the third chat room.

Unlike the second chatbot service, the first chatbot service is not a chatbot service that is used by adding a chatbot to an existing chat room, but rather a chatbot service that is used individually by a user account participating in the third chat room. Therefore, in the third chat room, a different user account other than the user account of the user terminal 20 may use a chatbot service through the connection interface for connecting to the first chatbot service, without adding the second chatbot to the third chat room.

In addition, when the server 10 provides the third chat room with the second chatbot message that is requested to be shared, the server 10 may provide, through the second chatbot's message, a chatbot add interface for adding the second chatbot to the third chat room. Specifically, the chatbot add interface for adding the second chatbot may be included and provided in the second chatbot message provided through the third chatroom.

Whether and how to provide the above-described connection interface or chatbot add interface may be determined based on whether the second chatbot has already been added to the third chat room. For example, when the server 10 provides the third chat room with a message from the second chatbot that is requested to be shared, the second chatbot may have already been added to the third chat room. In such cases, any user account participating in the third chat room is able to use the second chatbot service through the third chat room, so the connection interface and the chatbot add interface may not be provided.

In addition, when the user terminal 20 uses both the first and second chatbot services, one of the first and second chatbot services may be provided based on a usage history of the other one.

For example, the user terminal 20 may use the first chatbot service after using the second chatbot service. In this case, the service of the first chatbot may be provided based on a second chatbot history of the user terminal 20.

For example, the user terminal 20 may complete a ‘golf reservation for April 19’ using the second chatbot service through the second chat room, and thereafter request information on his or her ‘reserved golf schedule’ using the first chatbot service. In this case, the server 10 may provide information on the ‘reserved golf schedule for April 19’ as a message to the first chatbot based on the user's usage history in the second chatbot service that corresponds to the first chatbot service.

As another example, when requesting information on ‘Today's Weather’ through the first chatbot service, the user terminal 20 may transmit information designating ‘Incheon’ as a region of interest to the server 10. Thereafter, when the user terminal 20 requests information on ‘Tomorrow's Weather’ using the second chatbot service through the second chat room, the server 10 may provide information on ‘Tomorrow's Weather’ in ‘Incheon’ as a message from the second chatbot based on the user's designation of ‘Incheon’ as a region of interest in the first chatbot service.

While providing a chatbot service, the server 10 may set command rules (command guide) for the chatbot service. The command rules refer to information on predefined commands that users may use to request a chatbot service. For example, in a chatbot service that provides weather information, even if the user terminal 20 inputs only simple time-related information such as ‘Today’, ‘Tomorrow Morning’, or ‘Weekend’ as a command, the server 10 may be configured to provide weather information corresponding to a relevant time point based on the current location of the user terminal 20, according to the command rules.

The first and second chatbot services operating in a corresponding relationship may have identical or similar command rules. In the present disclosure, the command rules may correspond to correspondence information associated with the corresponding relationship of the chatbots.

While providing a chatbot service, the server 10 may provide the user terminal 20 with command guide information. The command guide information may be information that provides guidance on recommended commands or available commands to help a user easily input a command based on the command rules of the chatbot service. For example, in a chatbot service that provides stock information, if the user terminal 20 inputs a command such as ‘Today's Stock Price’, the server 10 may provide options of stocks of interest, which are set in advance by the user terminal 20 in response to the command ‘Today's Stock Price’, as command guide information. When the user terminal 20 selects a specific item from the command guide information, the server 10 may provide stock price information for the selected specific item in the form of a chatbot message.

The first and second chatbot services operating in a corresponding relationship may have identical or similar command guide information. In the present disclosure, command guide information may be correspondence information associated with a corresponding relationship of chatbots.

The server 10 may use the same command rules or command guide information for the first and second chatbot services to reduce a storage space and a data processing volume. In addition, since users can use the first and second chatbot services based on the same command rules and command guide information, the convenience of using chatbot services may be improved.

The server 10 may generate or acquire a chatbot message through a chatbot engine. The chatbot engine is a server or application that generates chatbot messages based on a predefined criterion or method. The chatbot engine may be included in the server 10 or provided separately from the server 10 so that the server 10 can access the chatbot via a network or the like.

When the server 10 receives, from the user terminal 20, a command requesting provision of messages from the first and second chatbots, the server 10 may request the chatbot engine to generate a message in response to the command. Thereafter, the server 10 may acquire the message in response to the command from the chatbot engine.

The server 10 may use the same chatbot engine for the first and second chatbots. Therefore, the first and second chatbots may be operated by the same operator (the operator of the chatbot engine). While providing command information received from the user terminal 20 to the chatbot engine, the server 10 may also provide information indicating which of the first and second chatbot services the command information is based on.

The chatbot engine may generate different chatbot messages in response to the same command information, depending on whether the command information is based on the first or second chatbot service. However, in some cases, the chatbot engine may also generate the same chatbot message in response to the same command information, regardless of whether the command information is based on the first or second chatbot service.

When the chatbot engine generates different chatbot messages based on a chatbot service in response to the same command information, the chatbot engine may generate appropriate chatbot messages based on the features of the chatbot service.

For example, suppose that a first chatbot service is provided through a one-on-one chat room (first chat room) and a second chatbot service is provided through a second chat room with four user accounts. In this case, when the user terminal 20 sends a command, ‘Recommend a good place to eat in Pangyo right now’ through the first chatbot service, the chatbot engine may generate a chatbot message by giving high priority to solo-dining restaurants in a list of recommended restaurants, based on the fact that the first chatbot service is a one-on-one chat room service. However, when the user terminal 20 transmits the same command through the second chatbot service, the chatbot engine may generate a chatbot message by giving high priority to four-person restaurants in a list of recommended restaurants, based on the fact that the second chat room associated with the second chatbot service is a four-user chat room.

In operation 203, while providing the second chatbot service, the server 10 may provide various functions associated with the second chatbot participating in the second chat room to provide the chatbot service.

As an example, the server 10 may provide a function to remove or block the second chatbot from the second chat room. The server 10 may determine the inappropriateness of the chatbot service provided by the second chatbot, based on the chatbot messages or the like of the second chatbot, in relation to harmfulness, violence, profanity, vulgarity, obscenity, and the like. In addition, the server 10 may receive reports about the second chatbot from user accounts participating in the second chatroom and reflect the reports in determining inappropriateness of the second chatbot.

When it is determined that the chatbot fails to meet an appropriateness criterion required to continue providing a chatbot service, the server 10 may remove the second chatbot from the second chat room, block a request to add the second chatbot to a chat room, or temporarily or permanently suspend provision of the chatbot service.

If the server 10 temporarily suspend provision of the second chatbot service based on the inappropriateness of the second chatbot, the provision of the second chatbot service may be resumed when it is confirmed that the inappropriateness of the second chatbot is resolved. For example, if an error occurs in the chatbot engine of the second chatbot and an inappropriate chatbot message is generated, the server 10 may temporarily suspend provision of the second chatbot service and resume the provision of the second chatbot service when the error in the chatbot engine is resolved.

The server 10 may take the same action not only for the second chat room but also for other chat rooms where the second chatbot participates, based on the inappropriateness of the second chatbot. For example, if the second chatbot is added to both the second chat room and the third chat room to provide the second chatbot service and the server 10 confirms that the second chatbot is inappropriate for the second chatbot service in the second chat room, the server 10 may remove the second chatbot from not only the second chat room but also the third chat room. This is because even if the second chatbot is added to another chat room to provide the second chatbot service, the second chatbot may still be considered inappropriate in the other chat room as well, since the second chatbot operates based on the chatbot engine.

The server 10 may take the same or similar action on the first chatbot that corresponds to the second chatbot based on the inappropriateness of the second chatbot. For example, when the server 10 confirms the inappropriateness of the second chatbot in relation to the second chatbot service, the server 10 may take actions such as removing the first chatbot from the chat room or suspending provision of the service even if the inappropriateness of the first chatbot in relation to the first chatbot service is not confirmed. This is because, as described above, if the first and second chatbots operate in a corresponding relationship, the same inappropriateness may be recognized for the first and second chatbots because the first and second chatbots operate based on the same chatbot engine.

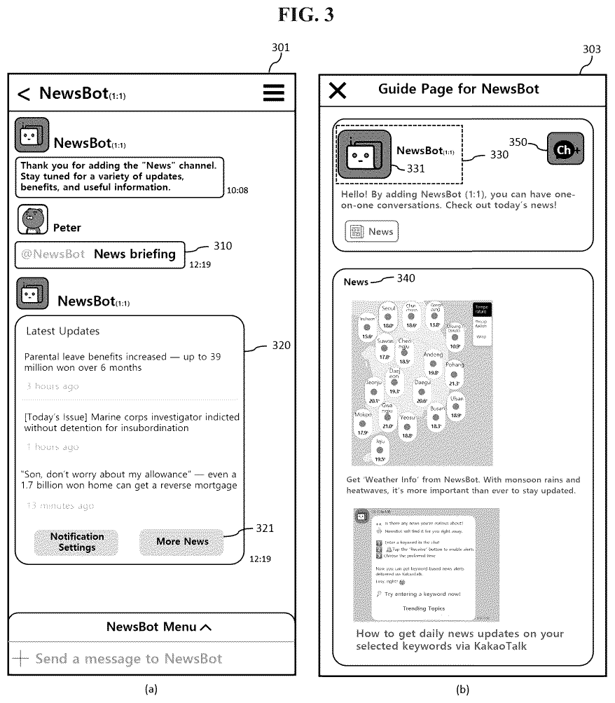

Hereinafter, examples of a method for displaying a chatbot service by a user terminal 20 of the present disclosure will be described with reference to FIGS. 3 to 12.

FIG. 3 illustrates a screen in which a user terminal 20 according to one embodiment of the present disclosure displays a one-on-one chat room 301 with a first chatbot and guide information 303 for a first chatbot.

In FIG. 3, (a) illustrates a screen where the user terminal 20 uses a first chatbot service.

In FIG. 3, (b) illustrates a screen where the user terminal 20 displays the guide information 303 of the first chatbot.

Referring to (a) of FIG. 3, the user terminal 20 may receive the first chatbot service from the server 10. When the user terminal 20 receives the first chatbot service, the user terminal 20 may use the first chatbot service through the one-on-one chat room 301 with the first chatbot.

Specifically, the user terminal 20 may display a chatbot message 320 of the first chatbot in response to a command message 310 for the first chatbot. For example, if the first chatbot is NewsBot (1:1), the user terminal 20 may receive a command message such as “@NewsBot News Briefing” 310 and display a chatbot message such as News Briefing 320 of the NewsBot (1:1).

In addition, the user terminal 20 may display additional information on the first chatbot in response to an interaction with the first chatbot's profile image or chatbot message 320. Referring to FIG. 3, the user terminal 20 may display additional information on the first chatbot in response to a user interaction with an interface 321 included in the first chatbot's profile image or the chatbot message 320. The additional information may be a guide page for the first chatbot, as shown in (b) of FIG. 3.

Referring to (b) of FIG. 3, the user terminal 20 may display a guide page 303 for the first chatbot. The guide page 303 for the first chatbot may include various information. Specifically, the guide page 303 may include the first chatbot's name (e.g., NewsBot (1:1)), profile information 330, profile image information 331, content information 340, and an interface 350 associated with a request for use of the first chatbot service.

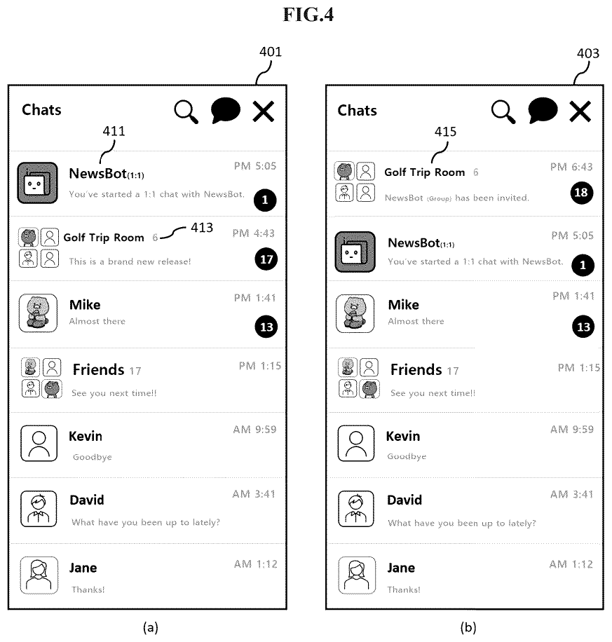

FIG. 4 is a screen of a chat room list associated with a first chat service and a second chat service according to one embodiment of the present disclosure.

In FIG. 4, (a) is a screen of a chat room list where a first chat room is created in which the first chat service is provided to the user terminal 20. In FIG. 4, (b) is a screen of a chat room list in which information on a second chatbot is displayed in a second chat room where a second chat service is provided to the user terminal 20.

Referring to (a) of FIG. 4, the user terminal 20 may display a newly created first chat room 411 in a chat room list 401. Specifically, when the user terminal 20 requests the server 10 to use a first chatbot service, the server 10 may newly add a first chat room 411 to a participating chat room list 401 and provide the updated list to the user terminal 20.

Referring to (a) of FIG. 4, a second chat room 413 may be included in the participating chat room list 401 of the user terminal 20 before receiving a request to add a second chatbot.

Referring to (b) of FIG. 4, when the user terminal 20 requests to use a second chatbot service, the server 10 may add a second chatbot to a second chat room 415 and provide additional information on the second chatbot through a chat room list 403 of the user terminal 20.

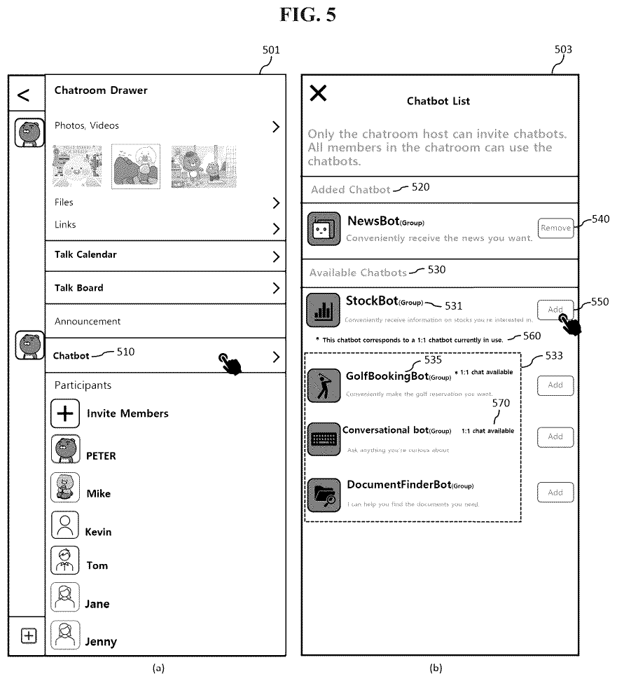

FIG. 5 illustrates a screen in which the user terminal 20 adds StockBot (Group) through a second chat room 501 according to one embodiment of the present disclosure.

In FIG. 5, (a) illustrates a screen displaying an interface 510 that allows a user terminal 20 to display a chatbot list to add a second chatbot to the second chat room 501. In FIG. 5, (b) illustrates a screen in which the user terminal 20 selects a second chatbot 531 from the chatbot list and adds the second chatbot 531 to the second chat room 501.

The user terminal 20 may display the chatbot list to add the second chatbot corresponding to the second-type chatbot service from the user. Specifically, when the user terminal 20 acquires an interaction with an interface 510 capable of displaying a chatbot list, the user terminal 20 may display a chatbot list 503 including at least one chatbot 521 and 523.

Referring to (b) of FIG. 5, the chatbot list 503 may include information 520 on a chatbot added to the second chat room and information 530 on chatbots available for addition. In addition, the chatbot list 503 may include an interface 540 for exiting an added chatbot and an interface 550 for adding an unadded chatbot.

If the user terminal 20 is using a first chatbot service, a second chatbot service corresponding to the first chatbot service is highly likely to be used together in a group chat room. Accordingly, in the chatbot list 503, the second chatbot 531 corresponding to the first chatbot being used by a user from the chatbot list 503 may be displayed separately from other chatbots not being used by the user. Specifically, when the user terminal 20 uses the first chatbot service, the user terminal 20 may display, in the chatbot list 503, information 560 that the user account is currently using a one-on-one chatbot with which the second chatbot 531 operates in a corresponding relationship.

The chatbot list 503 may include information 570 indicating whether the first chatbot service is provided to the first-type chatbot that operates in a corresponding relationship with the second-type chatbot. Specifically, in (b) of FIG. 5, all chatbots included in the chatbot list 503 may correspond to the second type chatbot. An operator providing a chatbot service may only provide a second-type chatbot service without the first-type chatbot service. In this case, the chatbot list 503 may include the information 570 on whether the first-type chatbot corresponding to each second type chatbot provides the first chatbot service.

For example, when the server 10 provides a chatbot service of a first-type chatbot GolfBookingBot (1:1), which operates in a corresponding relationship with a second type chatbot GolfBookingBot (Group) 535, information such as ‘1:1 chat available’ 570 may be displayed together, as shown in (b) of FIG. 5.

When a selection interaction 550 for adding one of the chatbots included in the chatbot list 503 is received from the user terminal 20, the server 10 may add the selected chatbot to the second chat room 501. In this case, the user terminal 20 may use a chatbot service of the selected chatbot.

In some cases, a user account may be required to have a predefined permission in order to add a chatbot to a chat room. For example, the user account may be an administrator of the second chat room 501 and thus have the authority to add a chatbot the second chat room 501.

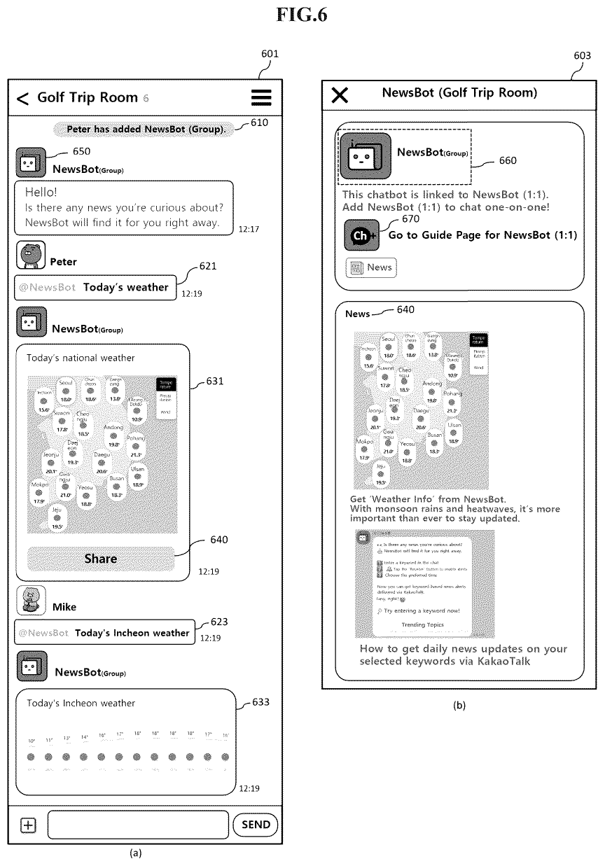

FIG. 6 illustrates a screen in which the user terminal 20 according to one embodiment of the present disclosure displays chatbot messages 631 and 633 of NewsBot (Group) in a second chat room 601.

In FIG. 6, (a) illustrates a screen where the user terminal 20 uses a chatbot service of NewsBot (Group). In FIG. 6, (b) illustrates a screen in which a plurality of user terminals 20 participating in the second chat room 601 display guide information 603 for NewsBot (Group).

Referring to (a) of FIG. 6, the user terminal 20 may add NewsBot (Group) to the second chat room 601. When NewsBot (Group) is added to the second chat room 601, the user terminal 20 may display a feed message 610 indicating that NewsBot (Group) has been added. In addition, the user terminal 20 may display a participation message of NewsBot (Group).

When NewsBot (Group) is added to the second chat room 601, the user terminal 20 may use a chatbot service of NewsBot (Group). Specifically, the user terminal 20 may transmit a command message 621 to NewsBot (Group) to the second chat room 601. When the server 10 receives a command message from the user terminal 20, the server 10 may provide a chatbot message 631 corresponding to the command to the user terminal 20. For example, the user terminal 20 may display the chatbot message 631, such as “Today's National Weather,” in response to a command message such as “@NewsBot Today's Weather” 621.

In addition, when NewsBot (Group) is added to the second chat room 601 by the user terminal 20, other user terminals participating in the second chat room 601 may also use the chatbot service of NewsBot (Group). For example, even if Peter adds NewsBot (Group) to the second chat room 601, Mike may also use the chatbot service of NewsBot (Group), as shown in (a) of FIG. 6. Specifically, in response to a command message such as Mike's “@NewsBot Today's Incheon Weather” 623, the user terminal 20 may display a chatbot message 633 such as “Today's Incheon Weather.”

The chatbot message 631 of NewsBot (Group) may include an interface 640 for sharing the chatbot message 631 with a different chat room. The user terminal 20 may share the chatbot message 631 of the second chat room 601 with a different chat room 700 through the interface 640.

Referring to (b) of FIG. 6, a guide page 603 for NewsBot (Group) may include an interface 670 associated with the first chatbot service. Specifically, when an interaction with NewsBot's profile image 650 is received, the user terminal 20 may display the guide page 603 for NewsBot (Group).

The guide page 603 may correspond to the guide page 603 for NewsBot (1:1), shown in (b) of FIG. 3. Accordingly, at least some items 660 and 670 in the guide page 603 may be identical to those in the guide page 303 shown in (b) of FIG. 3. Specifically, in the guide page 603 for NewsBot (Group), part of the name information and profile information and the profile image information 660 may be correspondence information based a corresponding relationship (i.e., identical information).

The guide information 603 for NewsBot (Group) may include a connection interface 670 for connecting to the first chatbot service. When an interaction with the interface 670 is obtained, the user terminal 20 may display the guide page 303 for the first chatbot.

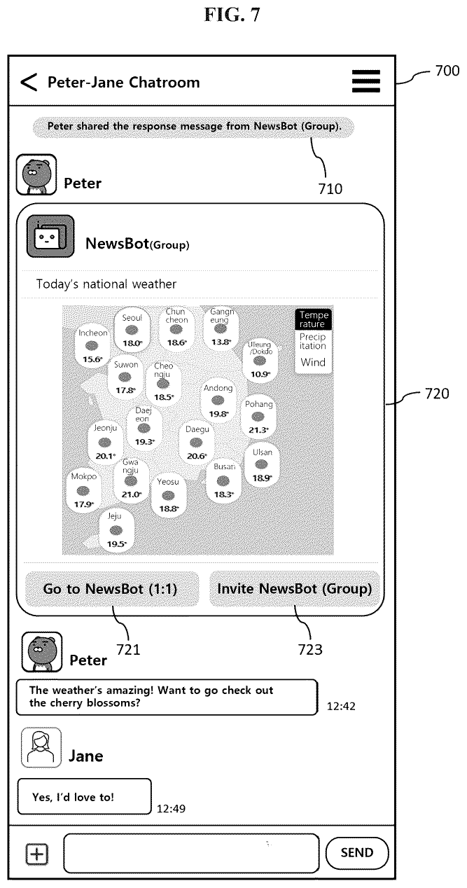

FIG. 7 illustrates a screen in which the user terminal 20 according to one embodiment of the present disclosure shares a chatbot message from a second chatbot to a third chat room 700.

The screen of FIG. 7 may be displayed in response to an interaction with an interface 640 that may be shared with a different chat room in FIG. 6.

Referring to FIG. 7, when a chatbot message from a second chatbot is shared with a third chatroom 700, the user terminal 20 or a terminal participating in the third chatroom may display a feed message including information 710 that a chatbot message from the second chatbot has been shared. In addition, when the chatbot message from the second chatbot is shared with the third chatroom 700, a connection interface 721 for connecting to a first chatbot service through the third chatroom 700 and a chatbot add interface 723 for adding a second chatbot to the third chatroom 700 may be displayed.

For example, when a user terminal (Peter's terminal) 20 shares a spoken message from NewsBot (Group) to a chat room with Jane, the user terminal 20 and Jane's terminal may display a message 720 including an interface 721 for connecting to NewsBot (1:1) and an interface 723 for adding NewsBot (Group).

When a terminal participating in the third chat room 700 acquires interaction with the connection interface 721, the terminal participating in the third chat room 700 may display the guide page 303 for the first chatbot.

In addition, when the server 10 receives an interaction with the addition interface 723 from the terminal participating in the third chat room 700, the server 10 may cause NewsBot (Group) to participate in the third chat room 700 and provide the chatbot service of NewsBot (Group) through the third chat room.

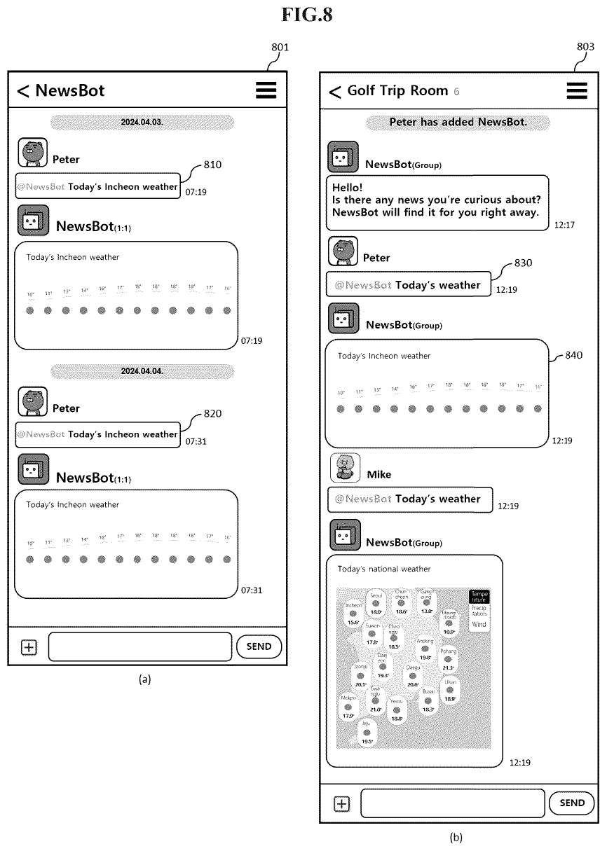

FIG. 8 illustrates a screen in which the user terminal 20 according to one embodiment of the present disclosure displays a chatbot message 840 from a second chatbot based on chat histories 810 and 820 of a first chatbot.

In FIG. 8, (a) illustrates a screen in which the user terminal 20 uses a first chatbot service through a one-on-one chat room 801 with the first chatbot.

In FIG. 8, b illustrates a screen in which the user terminal 20 uses a second chatbot service through a second chat room 803.

Referring to (a) of FIG. 8, the user terminal 20 may transmit a command 810 or 820 to the first chatbot in the one-on-one chat room 801 with the first chatbot. The user terminal 20 may display a chatbot message corresponding to the command 810 or 820.

For example, Peter may repeatedly input a command such as “@NewsBot Today's Incheon Weather” 810 or 820. In this case, the user terminal 20 may repeatedly display “Information about Today's Incheon Weather” in the form of a spoken message from NewsBot (1:1).

Referring to (b) of FIG. 8, the user terminal 20 may transmit the command 830 to the second chatbot to the second chat room 803. The user terminal 20 may display a chatbot message 840 corresponding to the command 830. In this case, a response message 840 may be based on the chat history of the one-on-one chat room 801.

For example, as described above in (a) of FIG. 8, the user terminal (Peter's terminal) 20 may repeatedly display “Information about Today's Incheon Weather” 810 or 820. Thereafter, when the user terminal (Peter's terminal) 20 inputs a command such as “@NewsBot Today's Weather” 830 in the second chat room 803, the user terminal 20 may display “Information about Today's Incheon Weather” 840 in the form of a spoken message from the NewsBot (Group) based on the chat history of the one-on-one chat room between Peter and NewsBot (1:1).

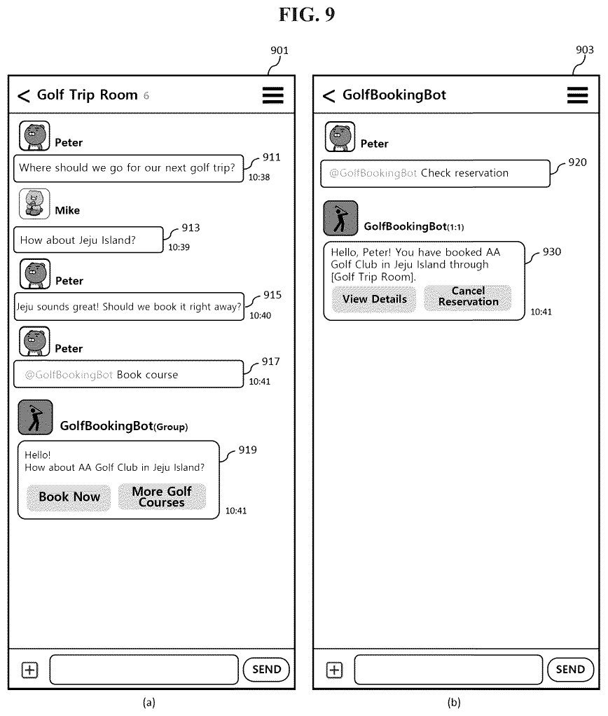

FIG. 9 illustrates a screen in which a user terminal 20 according to one embodiment of the present disclosure displays a response message 930 from a first chatbot based on chat histories 911, 913, 915, 917, and 919 of a plurality of user terminals participating in a second chat room and a second chatbot.

In FIG. 9, (a) illustrates a screen in which the user terminal 20 uses the second chatbot service through the second chatbot and a second chat room 901.

In FIG. 9, (b) illustrates a screen in which the user terminal 20 uses the first chatbot service through a one-on-one chat room 903 with the first chatbot.

Referring to (a) of FIG. 9, the plurality of user terminals participating in the second chat room may transmit a command 917 to the second chatbot. In addition, the plurality of user terminals may transmit input messages 911, 913, and 915 to the second chat room 901.

For example, the plurality of user terminals participating in the second chat room may send, to the second chat room 901, input messages such as “Where should we go for our next golf trip?” 911 (by Peter), “How about Jeju Island?” 813 (by Mike), and “Jeju Island is great! Should we book it right away?” 915 (by Peter). In addition, the user terminal (Peter's terminal) 20 may display a message 919 of a chatbot associated with golf reservation in response to a command, such as “@GolfBookingBot Golf Course Booking” 917, for GolfBooking Bot (Group).

Although not shown in the drawings, the user terminal 20 may make a reservation for “Jeju Island AA Golf Course” through the message 919 from the chatbot.

Referring to (b) of FIG. 9, the user terminal 20 may transmit a command 920 such as ‘Check Reservation’ to the first chatbot in the one-on-one chat room 903. In this case, the user terminal 20 may display a chatbot message such as golf reservation information (e.g., Jeju Island AA Golf Course has been booked in the Golf Trip chat room) 930 based on the chat history of the second chat room 901.

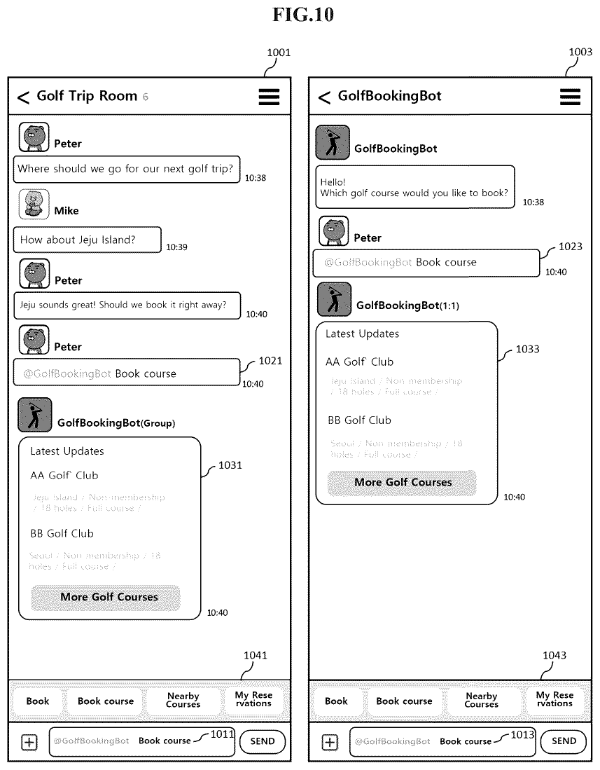

FIG. 10 illustrates a screen in which a user terminal 20 according to one embodiment of the present disclosure displays correspondence information associated with a corresponding relationship between first and second chatbots.

In FIG. 10, (a) illustrates a screen that displays a command 1021 for the second chatbot, a chatbot message 1031 from the second chatbot, and command guide information 1041 associated with the command of the second chatbot.

In FIG. 10, (b) illustrates a screen that displays a command 1023 for the first chatbot, a chatbot message 1033 from the first chatbot, and command guide information 1043 associated with the command for the first chatbot.

Referring to (a) and (b) of FIG. 10, the user terminal 20 may display the same commands 1021 and 1023, chatbot messages 1031 and 1033 from chatbots, and command guide information 1041 and 1043 in a second chat room 1001 and a first chat room 1003, respectively.

Specifically, when the user terminal 20 transmits the same command messages (e.g. @GolfBookingBot Golf Course Booking) 1011 and 1013 to the respective chat rooms 1001 and 1003, the user terminal 20 may display the same chatbot messages 1031 and 1033 from the same first and second chatbots.

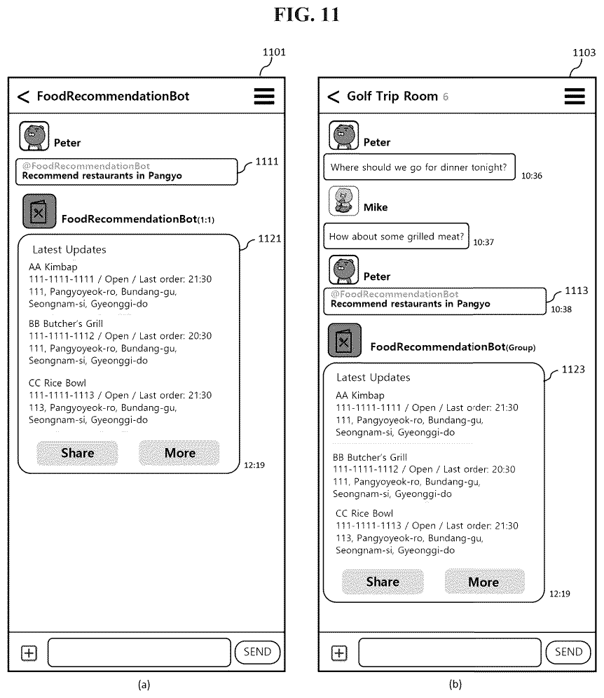

FIG. 11 illustrates a screen in which a user terminal 20 according to one embodiment of the present disclosure displays different chatbot messages 1121 and 1123 corresponding to the same commands 1111 and 1113.

In FIG. 11, (a) illustrates a screen for entering a specific command 1111 for a first chatbot in a first chat room 1101.

In FIG. 11, (b) illustrates a screen for inputting a specific command 1113 for a second chatbot in a second chat room 1103.

The server 10 may generate or receive chatbot messages through a chatbot engine. In general, the chatbot engine may generate the same chatbot message in response to the same command received from the user terminal 20, regardless of a first or second chatbot system. However, in some cases, the chatbot engine may generate different chatbot messages depending on whether the command is associated with the first chatbot service or the second chatbot service.

Referring to (a) and (b) of FIG. 11, the user terminal 20 may transmit the same command 1111 and 1113 to the respective chat rooms 1101 and 1103. Specifically, the user terminal 20 may transmit a command such as “@FoodRecommendationBot Pangyo restaurant recommendation” to a chat room. The user terminal 20 may display chatbot messages 1121 and 1123 corresponding to the command. In this case, the chatbot messages 1121 and 1123 may include different content depending on whether the chatbot is associated with a first chat service or a second chat service.

For example, (a) of FIG. 11 may be the example of the first chat service and a one-on-one chat room 1101 between Peter and FoodRecommendationBot (1:1). In this case, when a command such as “@FoodRecommendationBot Pangyo restaurant recommendation” is received, the server 10 may provide restaurant recommendation information 1121 including solo-dining restaurants.

However, (b) of FIG. 11 may be the example of the second chat service and a second chat room 1103 between a plurality of user accounts and FoodRecommendationBot (Group). In this case, when a command such as “@FoodRecommendationBot Pangyo restaurant recommendation” is received, the server 10 may provide restaurant recommendation information 1123 excluding solo-dining restaurants.

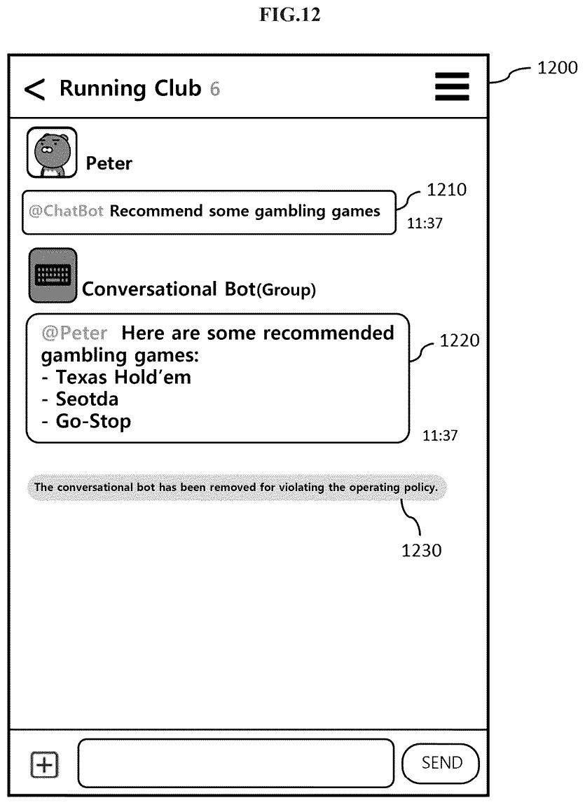

FIG. 12 illustrates a screen in which the user terminal 20 removes ConversationalBot from a second chat room 1200 according to one embodiment of the present disclosure.

Referring to FIG. 12, the user terminal 20 may remove ConversationalBot. Specifically, the user terminal 20 may remove ConversationalBot according to the operating policy of a chat service. In this case, the operating policy may be to remove ConversationalBot if at least one of the chatbot's command, name, profile information, profile image, and guide information includes harmful information.

For example, the user terminal 20 may transmit an input message such as “@ConversationalBot Recommend gambling games” 1210 to the second chat room 1200. The user terminal 20 may display ConversationalBot's message “Here are some recommended gambling games: Texas Hold'em, Seotda, and Go-Stop” 1220 corresponding to the input message.

In this case, if providing information associated with gambling is against the operating policy, the server 10 may suspend provision of ConversationalBot's service to the second chat room 1200. Accordingly, the user terminal 20 may display information associated with the chatbot's remove from the second chat room 1200 (e.g., “ConversationalBot has been removed for violating the operating policy.”) 1230.

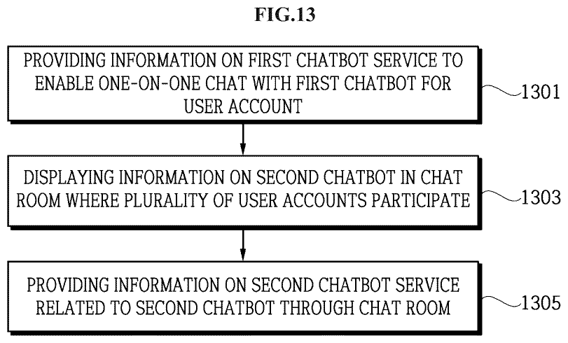

FIG. 13 is a flowchart illustrating a method for providing a chatbot service by a user terminal 20 of the present disclosure.

For convenience of explanation, descriptions of operations in FIG. 13 that are substantially the same as those in FIG. 2 will be replaced with references to FIG. 2.

In operation 1301, the user terminal 20 provides information on a first chatbot service to enable one-on-one chatting with the first chatbot for a user account. Since operation 1301 is substantially the same as operation 201 of FIG. 2, the description of operation 1301 is replaced with the description of operation 201 of FIG. 2.

In operation 1303, the user terminal 20 displays information on the second chatbot in a chat room where a plurality of user accounts participate. In operation 1305, the user terminal 20 provides information on a second chatbot service associated with the second chatbot through a chat room.

Since operations 1303 and 1305 are substantially the same as operation 203 of FIG. 2, the description of operations 1303 and 1305 is replaced with the description of operation 203 of FIG. 2.

According to the present disclosure, a chatbot service may be provided in a chat room through a chatbot added to the chat room in which a plurality of user accounts participate, thereby simultaneously providing the chatbot service to the plurality of user accounts participating in the chat room.

According to the present disclosure, the convenience of chatbot services may be improved by enabling a server to provide different chatbots operating in a corresponding relationship as different types of chatbot services and to provide correspondence information based on the corresponding relationship to a user terminal.

The technical features disclosed in each embodiment of the present disclosure are not limited to a corresponding embodiment, and unless incompatible with each other, the technical features disclosed in each embodiment may be applied in combination to other embodiments.

Therefore, although each embodiment is described mainly about an individual technical feature, the technical features of the embodiments of the present disclosure may be applied in combination, unless incompatible with each other.

The present disclosure is not limited to the above-described embodiments and the accompanying drawings, and various modifications and changes may be made in view of a person skilled in the art to which the present disclosure pertains. Therefore, the scope of the present disclosure should be determined by the scope of the appended claims, and equivalents thereof.

What is claimed is:

1. A method for providing a chatbot service by a server, comprising:
providing a first chatbot service to enable one-on-one chatting with a first chatbot; and
in response to a request received from a user terminal to add a second chatbot to a chat room where a plurality of user accounts participate, providing a second chatbot service through the chat room to enable chatting with the second chatbot,
wherein the first chatbot and the second chatbot operate in a corresponding relationship.

2. The method of claim 1, wherein first chatbot information provided through the first chatbot service and second chatbot information provided through the second chatbot service comprise correspondence information associated with the corresponding relationship.

3. The method of claim 2, wherein the correspondence information comprises at least one of chatbot name information, chatbot profile information, chatbot profile image information, chatbot guide information, or predefined command information requesting a chatbot to provide a message.

4. The method of claim 3 wherein the command information comprises at least one command interface that is provided for selection by a user account.

5. The method of claim 1, wherein providing the second chatbot service comprises providing a connection interface for connecting to the first chatbot service through the chat room.

6. The method of claim 5, wherein providing the connection interface comprises:
receiving, from a terminal of an account participating in the chat room, interaction information for at least one of profile information or a message of the second chatbot provided through the chat room; and
in response to the interaction information, providing information comprising the connection interface to the terminal of the account participating in the chat room.

7. The method of claim 1, further comprising:
in response to a request to share a message of the second chatbot, which is provided through the chat room, with a different chat room, providing the message through the different chat room,
wherein providing the message through the different chat room comprises providing a connection interface for connecting to the first chatbot service through at least one of profile information or the message of the second chatbot provided through the different chat room.

8. The method of claim 1, further comprising: in response to a request to share a message of the second chatbot, which is provided through the chat room, with a different chat room, providing the message through the different chat room,
wherein providing the message through the different chat room comprises providing a chatbot add interface for adding the second chatbot to the different chat room.

9. The method of claim 1, wherein providing the second chatbot service comprises:
providing a chatbot add interface for adding a chatbot to the user terminal through the chat room and receiving an interaction with the interface from the user terminal; and
providing a chatbot list comprising the second chatbot to the user terminal.

10. The method of claim 1, further comprising:
after providing the second chatbot service, providing the first chatbot service to a terminal of an account participating in the chat room,
wherein providing the first chatbot service to the terminal of the account participating in the chat room comprises providing the terminal with a message of the first chatbot based on a usage history associated with the second chatbot service.

11. The method of claim 1, wherein:
in providing the first and second chatbot services, the messages of the first and second chatbots are acquired from a same chatbot engine, and
the chatbot engine is included in the server or accessible by the server.

12. The method of claim 1,
wherein providing the second chatbot service further comprises suspending provision of the second chatbot service when the message of the second chatbot satisfies a predefined condition.

13. A server providing chatbot services, comprising:
a memory storing instructions, and
a processor configured to execute the instructions to:
provide a first chatbot service to enable one-on-one chatting with a first chatbot; and
in response to a request received from a user terminal to add a second chatbot to a chat room where a plurality of user accounts participate, provide a second chatbot service to enable chatting with the second chatbot through the chat room,
wherein the first chatbot and the second chatbot operate in a corresponding relationship.

14. A method for providing a chatbot service by a user terminal, comprising:
providing information on a first chatbot service to enable one-on-one chatting with a first chatbot for a user account;
displaying information on a second chatbot added to a chat room where a plurality of user accounts participate; and
providing information on a second chatbot service associated with the second chatbot through the chat room,
wherein the first chatbot and the second chatbot operate in a corresponding relationship.

15. The method of claim 14, wherein providing the information on the second chatbot service comprises displaying, through the chat room, a connection interface for connecting to a one-on-one chat service with the first chatbot.

16. The method of claim 15, wherein displaying the connection interface comprises:
receiving an interaction from a user with at least one of profile information or a message of the second chatbot, which is included in the information on the second chatbot; and
displaying the connection interface in response to the interaction.

17. The method of claim 14, further comprising:
displaying, through the third chat room, information indicating that the information on the second chatbot is shared with the third chat room,
wherein displaying the information indicating that the information on the second chatbot is shared with the third chat room comprises displaying a connection interface for connecting to a one-on-one chat service with the first chatbot, through the information on the second chatbot displayed through the third chat room.

18. The method of claim 14, wherein displaying the information on the second chatbot comprises:
displaying a chatbot add interface for adding a chatbot in the second chat room and receiving an interaction from a user with the interface; and
in response to the interaction, displaying a chatbot list comprising the second chatbot.
